(19) United States
(12) Patent Application Publication
(10) Pub. No.: US 2016/0311319 A1
(43) Pub. Date: Oct. 27, 2016

(54) A FINAL DRIVE FOR A ROAD VEHICLE

(71) Applicant: BORGWARNER TORQTRANSFER SYSTEMS AB, Landskrona (SE)

(72) Inventor: BO LUNDSTROM, GLUMSLOV (SE)

(21) Appl. No.: 15/103,620

(22) PCT Filed: Dec. 9, 2014
(86) PCT No.: PCT/EP2014/077072

§ 371 Date: Jun. 10, 2016

(30) Foreign Application Priority Data
Dec. 12, 2013 (SE) 1351484-9

(51) Int. Cl. B60K 17/35; B60K 23/08

(52) U.S. Cl. CPC B60K 17/35; B60K 23/0808; B60K 2023/0866

(57) ABSTRACT

A final drive for a road vehicle comprises a pinion gear (10) on a pinion axle (4), the pinion gear being in gear engagement with a crown gear (12) journaled for rotation transversely to the pinion axle (4). It is combined with an all wheel drive (A WD) coupling, comprising a disc package (2) axially controlled by a hydraulic piston (5) for optionally transmitting torque from an ingoing axle (3) to the pinion axle (4) as well as a disc drum (2A) or similar means for rotatably connecting the disc package (2) to the pinion axle. An axial stop (9, 9′) is arranged on the pinion axle (4) for transferring axial forces from the disc drum (2A) to the pinion axle.

### TECHNICAL FIELD

The present invention relates to a final drive for a road vehicle, comprising a pinion gear on a pinion axle, the pinion being in gear engagement with a crown gear journaled for rotation transversely to the pinion axle,

in combination with an all wheel drive (AWD) coupling, comprising a disc package axially controlled by a hydraulic piston for optionally transmitting torque from an ingoing axle to the pinion axle as well as a disc drum or similar means for rotatably connecting the disc package to the pinion axle.

### BACKGROUND OF THE INVENTION

A final drive of the above-mentioned kind is customary on rear-wheel driven road vehicles—cars. The trend nowadays, however, is towards all wheel drive (AWD) cars. In such a car, a front wheel drive can be supplemented with an intermediate axle, an AWD coupling, and a final drive for driving also the rear wheels.

When a car is to be provided with an AWD coupling, it is presently customary that the AWD coupling and the final drive (including the differential) are supplied from different sources. The design is often such that an AWD coupling/final drive-unit is formed in that the housing of the AWD coupling is physically attached to the housing of the final drive, the disc drum or similar means being connected to the pinion axle.

The supplier of the final drive thus provides the proper journaling therefore.

As is well known in the art, the journaling of the pinion axle in the final drive is rather intricate, because a certain pre-stress has to be provided, especially if the pinion gear/crown gear set is a hypoid gear set. The pinion axle is thus normally journaled by two conical roller bearings or angular contact bearings, which are prestressed by a nut arrangement to be manually tightened to the correct pre-stress value.

The rotatable parts of the AWD coupling are likewise to be separately journaled in the coupling housing (although one of the bearings may be provided between the ingoing axle of the coupling and the pinion axle).

Generally speaking, the provision of two separate (but connected) units means higher cost, weight, space requirement, and losses.

In the AWD coupling a clamping force is applied over the disc package by the hydraulic piston, from which the axial force is applied over an axial bearing, often a needle bearing. The force is then transferred back to the housing of the coupling over a second axial bearing, also often a needle bearing.

The disc drum is in splines engagement with the pinion axle without axial force transmission. The mounting together of the two units is simply performed in that the disc drum of the AWD coupling is pushed onto the pinion axle splines

Thus in principle, the final drive and the AWD coupling are separate, “self-sustained” units.

In the final drive it is necessary to provide the pinion gear with a certain pre-stress, which leads to considerable energy losses. Also the pinion bearings have to be comparatively big in order to cope with all forces and to provide the desired life-cycle. A drawback especially in the AWD coupling is relatively large energy losses due to the use of axial needle bearings at either side of the disc package in the coupling.

The main object of the invention is to remove these and other disadvantages with the present design.

### THE INVENTION

This is according to the invention attained by the provision of an axial stop, e.g. in the form of a locking ring means, on the pinion axle for transferring axial forces from the disc drum to the pinion axle.

As the axial forces from the disc drum are transferred to the pinion axle (and then back to the housing by its bearings), the need for an axial bearing at that side of the disc drum is eliminated. Only one axial bearing, preferably an axial needle bearing, is arranged between the hydraulic piston and the disc package.

The final drive and the AWD coupling are arranged in a housing, and the ingoing coupling axle is journaled in the housing by a radial bearing.

The pinion axle is preferably journaled in the end of the ingoing axle by means of a radial bearing, preferably a needle bearing.

### BRIEF DESCRIPTION OF THE DRAWINGS

The invention will be described in more detail below under reference to the accompanying drawings, in which

FIG. 1 is a sketch of a typical prior art arrangement of a vehicle final drive and an added AWD coupling and

FIG. 2 is a similar sketch of an integrated final drive and AWD coupling according to the invention.

FIG. 3 is a similar sketch of an integrated final drive and AWD coupling according to a further embodiment, while

FIG. 4 is a yet further sketch of an integrated final drive and AWD coupling according to an embodiment.

### DETAILED DESCRIPTION OF EMBODIMENTS

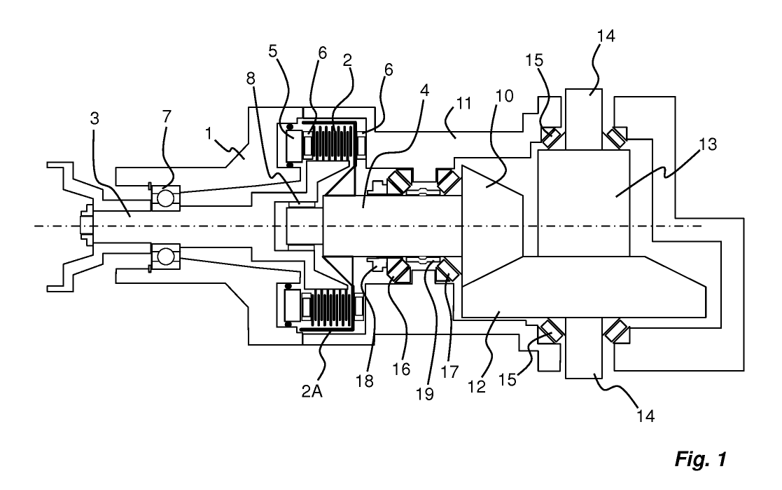

A typical prior art combination of a final drive and an AWD coupling in a road vehicle—a car—is shown in FIG. 1.

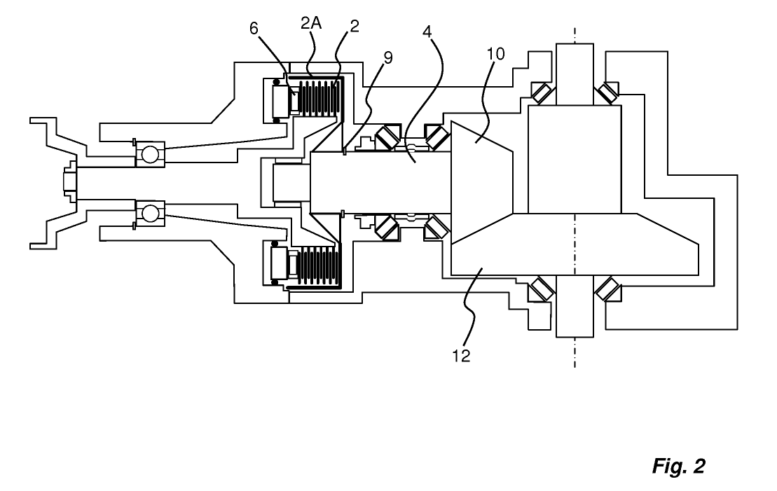

The description below—also of the inventive arrangement shown in FIG. 2—is focused on parts that are of importance for the proper understanding of the invention, as both the final drive and the AWD coupling are per se known and understood by persons skilled in the art.

In a coupling housing 1 a disc package 2 comprising a number of discs is arranged. These discs are alternatingly connected on one hand to a rotatably journaled ingoing axle 3 and on the other hand to a rotatably journaled outgoing axle 4 in the form of a pinion axle of the final drive (to be described). The connection to the outgoing axle 4 is performed via a disc drum 2A. The disc drum 2A is in splines engagement with the axle 4 and thus axially movable in relation thereto.

The disc package 2 is controlled by hydraulic pressure applied on a hydraulic piston 5 in the housing 1. The magnitude of the force from the hydraulic piston 5 will control the clamping force on and thus the torque transmitted by the disc package 2 from the ingoing axle 3 to the outgoing axle 4. The force from the piston 5 is transmitted to the disc package 2 and back into the housing 1 by means of axial bearings 6, preferably needle bearings.

The comparatively big axial needle bearings 6 at either side of the disc package 2 normally have a low load, but due to their large diameters they cause relatively large energy losses.

In the shown example, the ingoing axle 3 is journaled in the housing 1 by means of only a radial bearing 7, but the pinion axle 3 extends in a supporting fashion into the opposite end, where there is a radial bearing 8, preferably a needle bearing. In other examples there may be more than one bearing for the ingoing axle 3.

A pinion gear 10 (integral with the pinion axle 4) is rotatably journaled in a final drive housing 11, which is connected to the coupling housing 1. The final drive comprises the pinion gear 10 and a crown gear 12 to form a bevel gear set, normally a hypoid gear set. A differential housing 13 is connected to the crown gear 12 and contains a conventional differential mechanism, from which two half-axles 14 extend out to driving wheels of the vehicle. The arrangement may be journaled in the final drive housing 11 by combined axial and radial bearings 15.

Shown in FIG. 1 is a conventional journaling for a pinion gear in a hypoid gear set of a final drive. This journaling comprises two bearings, a forward bearing 16 and a rearward bearing 17. These two bearings 16, 17 shall be capable of taking up the radial and axial forces from the gear engagement in the hypoid gear set. They have to have the capability of handling forces in both axial directions, because the force direction changes for example between driving the vehicle in the forward and the reverse direction. The bearings 16, 17 are normally conical roller bearings or angular contact ball bearings.

For the proper functioning of the final drive, it is of great importance to prevent play from occurring in the journaling of the pinion gear 10. The normal way to accomplish this is to apply an axial prestress on the journaling by means of a nut 18, which is threaded on the pinion axle 4 and applies an axial force on the inner ring of the forward bearing 16. For ensuring that the nut 18 does not get loose under service, there is a plate sleeve 19 between the inner rings of the two bearings 16, 17. This sleeve is first deformed elastically and then plastically during the tightening of the nut 18. The elastic force will then remain and keep the nut 18 from loosening.

The magnitude of the prestress is so chosen that the deformation due to loads and temperature expansion does not result in any play. The constant prestress over the bearings 16, 17 results in considerable energy losses.

The construction shown in FIG. 1 is just one example of how to arrange the journaling of an AWD coupling, another being to journal the AWD coupling quite independently of the final drive.

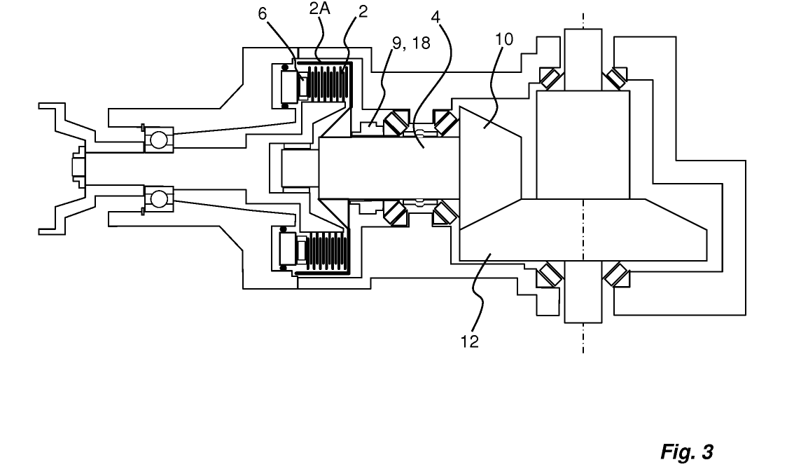

In the inventive solution according to FIG. 2 and FIG. 3 the integration between the AWD coupling and the final drive is more advanced.

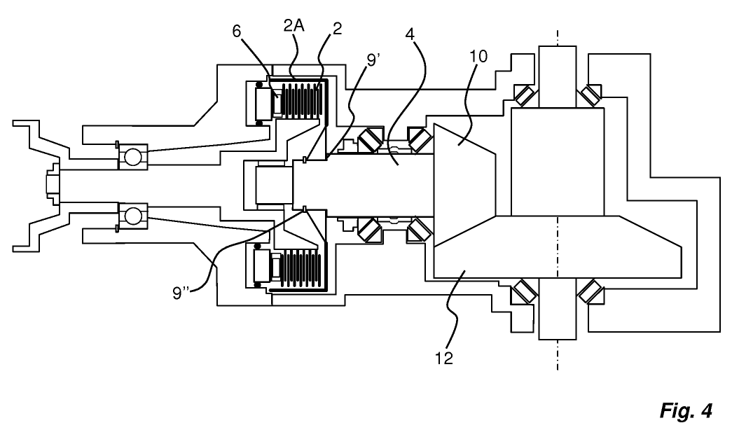

The main construction of the different elements in the inventive solutions according to FIG. 2, FIG. 3, and FIG. 4 have so much in common with the known arrangement shown in FIG. 1 that reference is mainly made to the description above. Also, FIG. 2, FIG. 3, and FIG. 4 are only provided with reference numerals to the extent necessary for a proper understanding.

In the arrangement according to FIG. 1 there is no interaction between the axial forces in the AWD coupling and the final drive, as there are axial bearings 6 at either side of the disc package 2 and as the disc drum 2A is in splines engagement with the pinion axle 4 without axial force transmission. The mounting together of the two units is simply performed in that the disc drum 2A is pushed into the splines engagement with the pinion axle, whereupon the two units are bolted together.

In the arrangements according to FIG. 2, FIG. 3, and FIG. 4 on the other hand there is axial force transmission provided from the disc drum 2A to the pinion axle 4, in the direction towards the pinion gear 10, by means of a lock ring 9 or the like on the pinion axle. In order to point to design alternatives, the numeral 9 may be said to designate a lock ring means, which would include any means integral with the axle and performing the same function as a locking ring.

As in the FIG. 1 arrangement the clamping force from the piston 5 to the disc package 2 is transmitted by an axial bearing 6. This axial force is, however, now transmitted via the disc drum 2A to the pinion axle 4 and back to the housing 11 via the pinion bearings. The need for an axial bearing to the right of the disc package 2 is hereby eliminated.

An obvious advantage with this is that only one axial bearing, normally a needle bearing, is needed for the disc package 2. The result is reduced losses, costs, and weight.

Further, at normal forward driving the clamping force from the disc package 2 will act on the pinion gear in opposite direction to the forces from the gear engagement in the final drive (pinion gear 10/crown gear 12). The result is that the axial load on the pinion bearings 16, 17 will be reduced, leading to reduced losses. As the pinion bearing load added over the life span of the arrangement is reduced, smaller pinion bearings may be chosen, also leading to reduced losses, costs, and weight.

As already been described, axial forces from the disc drum 2A are transmitted to the pinion axle 4 via the locking ring 9 shown in FIG. 2.

In FIG. 3 another embodiment is shown, in which the functionality of the locking ring 9 is replaced by arranging the pinion bearing pre-loading threaded nut 18 at an axial position such that the threaded nut 18 forms an axial stop for the disc drum 2A.

In FIG. 4 an alternative embodiment is shown, in which the locking ring 9 is replaced by a radial step 9′ of the pinion axle. The radial step 9′ forms a stop surface for the disc drum 2A, and provides the same effect in terms of axial force transfer as the locking ring 9 shown in FIG. 2, or the radial extension of the nut 18 shown in FIG. 3. Again referring to FIG. 4 an option lock ring 9″ may be provided on the opposite side of the pinion axle 4 (i.e. opposite relative the radial step 9′) for preventing the disc drum 2A to move axially away from the radial stop 9′.

In FIG. 2 and FIG. 4, the locking ring 9 and the radial step 9′ form an axial stop for the disc drum 2A.

In the description above and in the claims, reference has only been made to actuation of the disc package by hydraulic pressure. However, it is within the scope of the claims to actuate the disc package by any actuator, for example electrical or pneumatic.

Other modifications are possible within the scope of the appended claims.

1. A final drive for a road vehicle, comprising
a pinion gear on a pinion axle, the pinion gear being in gear engagement with a crown gear journaled for rotation transversely to the pinion axle, and
an all wheel drive (AWD) coupling, comprising a disc package axially controlled by a hydraulic piston, the hydraulic piston operating in a direction towards the pinion gear for connecting the disc package to the pinion axle,
an axial stop on the pinion axle for transferring axial forces from the disc drum to the pinion axle.

2. A final drive according to claim 1, wherein an axial bearing, preferably an axial needle bearing, is arranged between the hydraulic piston and the disc package.

3. A final drive according to claim 1, the final drive and the AWD coupling being arranged in a housing, wherein the ingoing coupling axle is journaled in the housing by a radial bearing.

4. A final drive according to claim 1, wherein the pinion axle is journaled in the end of the ingoing axle by means of a radial bearing, preferably a needle bearing.

5. A final drive according to claim 1, wherein the axial stop is a locking ring means.

6. A final drive according to claim 1, wherein the axial stop is a radial step.

7. A final drive according to claim 1, wherein the axial stop is a pinion bearing pre-loading threaded nut.
